(19) United States
(12) Patent Application Publication
(10) Pub. No.: US 2006/0158883 A1
(43) Pub. Date: Jul. 20, 2006

(54) Flexible decoration of light string and method for preparation thereof

(76) Inventor: Jeng-Shyong Wu, Hsin-Chu City (TW)

Correspondence Address: MCGLEW & TUTTLE, PC, P.O. BOX 9227, SCARBOROUGH STATION, SCARBOROUGH, NY, 10510-9227, US

(21) Appl. No.: 11/036,251

(22) Filed: Jan. 14, 2005

(51) Int. Cl. F21S 13/14

(52) U.S. Cl. 362/252

(57) ABSTRACT

A flexible decorative light string includes multiple luminaries connected with multiple electrical conductors in series, parallel or series and parallel to form grouped lighting strings. An insulator along with the grouped lighting strings extend in a longitudinal direction to contain and seal the luminaries and the electrical conductors within in the insulators. With this construction the luminaries and the electrical conductors are isolated from the outside to form flexible decorative lighting strings with one or both ends of the strings connected to the connectors to form a circuit loop.

### FIELD OF THE INVENTION

The present invention generally relates to a flexible decorative light string and a method for the preparation thereof, and more particularly to a flexible decorative light string to be sealed in an insulator (or insulating body) and method for preparation thereof.

### BACKGROUND OF THE INVENTION

The traditional decorative light string is generally used around a tree, window or door, or pre-arranged on a decorative sheet or a stand. Some traditional light strings are arranged on a three-dimensional body. However, such traditional light strings do not have any particular variation in appearance. Further, traditional light strings are easily damaged due to a lack of protection, which can lead to a short circuit.

### SUMMARY OF THE INVENTION

The present invention relates to a flexible decorative light string comprising multiple luminaries connected with multiple electrical conductors in series, parallel, or series and parallel, to form lighting strings which are generally circular or semi-circular in cross section. The decorative lighting string is made with an insulator around the basic lighting strings extending in a longitudinal direction. The insulator contains and seals the luminaries and the electrical conductors within the insulator. Thus, the luminaries and the electrical conductors are isolated from the environment by a flexible decorative insulator. One or both ends of the decorative strings are connected to electrical connectors to form a circuit loop.

The present invention also provides a method for the preparation of a flexible decorative light string comprising multiple luminaries with multiple electrical conductors to form a circuit loop of the light string, to combine single loop light strings in series or parallel to form single or multiple circuit loops of the light strings.

The present invention also provides positioning devices having a fixed element to fix electrical conductors and luminaries in a certain position in order to prevent them from causing a short circuit.

The present invention also provides for the use of a plastic extruder to make a light string to be sealed within the insulating plastic via a predetermined die shape used in the extruder to form flexible decorative light strings with an outward insulating body.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1A is a view showing a single loop flexible decorative light string of the present invention with twisted and wound connections between the luminaries and the electrical conductor;

FIG. 1B is a view showing a single loop flexible decorative light string of the present invention with welded connections between the luminaries and the electrical conductor;

FIG. 1C is a view showing a single loop flexible decorative light string of the present invention with crimped connections between the luminaries and the electrical conductor;

FIG. 1D is a view showing a single loop flexible decorative light string of the present invention with twisted and welded connections between the luminaries and the electrical conductor;

FIG. 2A is a view showing the connection of the luminaries and the electrical conductor in single loop light string of the present invention;

FIG. 2B is a view showing the light string of FIG. 2A, with the addition of non-electrical reinforcement line twisted around the electrical conductor;

FIG. 2C is a view showing the light string of FIG. 2B, with the addition of an insulator;

FIG. 2D is a cross-sectional view of FIG. 2C through section C-C;

FIG. 2E is a cross-sectional view of FIG. 2C through section D-D;

FIG. 3A is a view showing the connection of luminaries and the electrical conductor in single loop light string of the present invention;

FIG. 3B is a view showing the connection of luminaries and the electrical conductor in multiple loop light string of the present invention;

FIG. 3C is a view showing the light string of FIG. 3B with the addition an insulator;

FIG. 3D is a cross-sectional view of FIG. 3C through section A-A;

FIG. 3E is a cross-sectional view of FIG. 3C through section B-B;

FIG. 4A is a view showing the combination of the loops of FIG. 2A and FIG. 3A as a multiple loop light string of the present invention;

FIG. 4B is a view showing a multiple loop light string similar to that of FIG. 4A, but with a shifted orientation between the luminaries of the multiple loops;

FIG. 4C is a view showing the multiple loop light string of FIG. 4B, within a positioning device having a spacer;

FIG. 4D is a view showing the multiple loop light string and positioning device of FIG. 4C within an insulator;

FIG. 4E is a cross-sectional view of FIG. 4D through section E-E;

FIG. 4F is a cross-sectional view of FIG. 4D through section F-F;

FIG. 4G is a cross-sectional view of FIG. 4D through section G-G;

FIG. 5A is a view showing a single loop light string of the present invention;

FIG. 5B is a view showing a multiple loop light string of the present invention;

FIG. 5C is a view showing the light string of FIG. 5B with thermosetting tube;

FIG. 5D is a view showing the light string of FIG. 5C within an insulator;

FIG. 6A is a view showing a flexible decorative light string with adhesive tape having a single loop light string of the present invention;

FIG. 6B is a view showing a multiple loop light string with adhesive tape of the present invention;

FIG. 6C is a view showing the light string of FIG. 6B with adhesive tape;

FIG. 6D is a view showing the light string of FIG. 6C within an insulator;

FIG. 7A is a view showing the combination of the loops of FIG. 2A and FIG. 3A as a multiple loop light string of a further type of light string of the present invention;

FIG. 7B is a view showing the light string same as FIG. 7A in multi-loops light string;

FIG. 7C is a view showing a flexible decorative light string with thermosetting tube and adhesive tape;

FIG. 7D is a view showing a flexible decorative light string of FIG. 7C within an insulator;

FIG. 7E is a cross-sectional view of FIG. 7D through section H-H;

FIG. 7F is a cross-sectional view of FIG. 7D through section J-J;

FIG. 7G is a cross-sectional view of FIG. 7D through section K-K;

FIG. 8A is a cross-sectional view of spacer positioning devices in a flexible decorative light string of the present invention;

FIG. 8A-1 is a front view of the spacer of FIG. 8A;

FIG. 8B is a cross-sectional view of another spacer;

FIG. 8B-1 is a front view of the spacer of FIG. 8B;

FIG. 8C is a cross-sectional view of a further spacer;

FIG. 8C-1 is a cross-sectional view of FIG. 8C;

FIG. 8D is a cross-sectional view of a further spacer;

FIG. 8D-1 is a cross-sectional view of FIG. 8D;

FIG. 8E is a cross-sectional view of a further spacer;

FIG. 8E-1 is a cross-sectional view of FIG. 8E;

FIG. 8F is a cross-sectional view of a further spacer;

FIG. 8F-1 is a cross-sectional view of FIG. 8F;

FIG. 9A is an exploded view of connector in the flexible decorative light string of the present invention;

FIG. 9B is a view showing a fastening status of the connector;

FIG. 9C is an exploded view of another connector of the present invention;

FIG. 10A is a view showing the a flexible decorative light strings with connectors within the insulators;

FIG. 10B is a cross-sectional view of FIG. 10A through section L-L; and

FIG. 11A is a cross-sectional view of light strings and extruder for the insulator of the present invention;

FIG. 11B is a cross-sectional view of the solid insulating body;

FIG. 11C is a cross-sectional view of a hollow insulating body;

FIG. 11D is a cross-sectional view of hollow insulating body with an extension strip.

### DESCRIPTION OF THE PREFERRED EMBODIMENT

Referring to the drawings in particular, the prevent invention relates to a flexible decorative light string comprising multiple luminaries (light elements) being connected with multiple electrical conductors in series, parallel or series and parallel to form grouped lighting strings. An insulator is provided along with the grouped lighting strings extending in the longitudinal direction to contain and seal the luminaries and the electrical conductors within in the insulators. With this construction, the luminaries and the electrical conductors are isolated with respect to the outside to form a flexible decorative lighting strings. One or both ends of the strings are connected to the connectors to form a circuit loop.

The present invention also relates to a method for the preparation of a flexible decorative light string. The method comprises: (1) the formation of the string connection with multiple luminaries connected to multiple electrical conductors to form a circuit loop of a light string; (2) the combination of strings with single loop light strings being connected in series or parallel to form a single or multiple circuit loops of grouped light strings; (3) the use of an extrusion mold with a plastic extruder used to seal the grouped light strings in the longitudinal direction within the insulating plastic via a predetermined die of the extruder to form flexible decorative light strings with an outer insulating body.

Further, the products of the present invention can be flexible. When the flexible decorative light string of the present invention is used, it expands to form a large and three-dimensional structure of a pretty decorative light string. When the flexible decorative light string is not being used, it can be received within a small volume for the convenient packaging, transportation and storage. Thus the products produced according to the present invention are able to provide a highly economic and safe device.

The present invention provides for different combinations on the basis of different assemblies. Each combination is suitable to a different usage, place and effect to obtain the desired safety. In order to understand the present invention completely, the descriptions are provided for the preferred embodiments shown in the drawings:

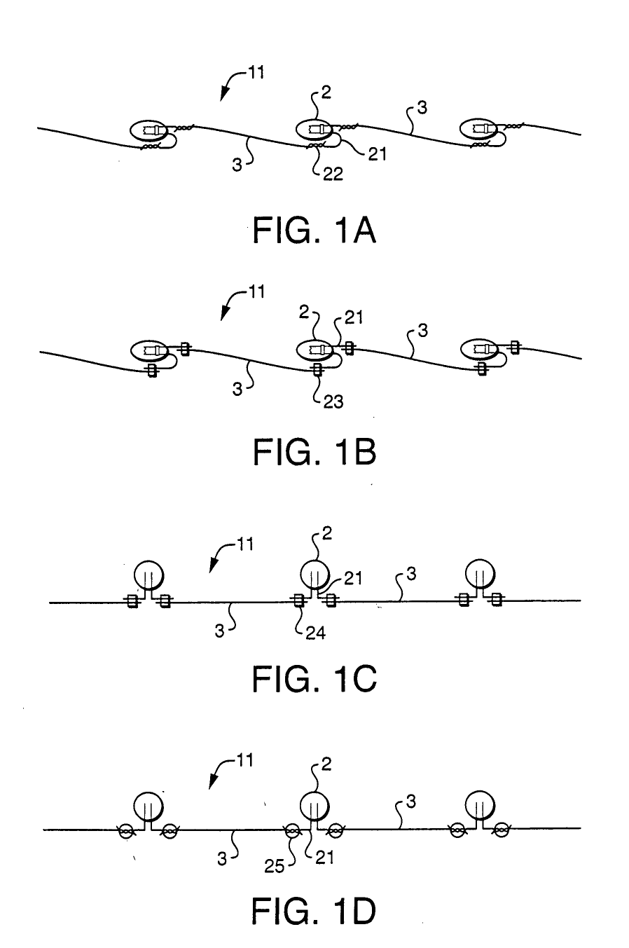

Referring to FIGS. 1A-1D, these drawings show a flexible decorative light string with a single loop light string of the present invention. FIG. 1A is an assembly of luminaries 2 and electrical conductor 3 in a single loop light string 11 of light string 1, in which the luminaries 2 via extendable conducting wire 21 are twisted and wound with electrical conductor 3 at twisted winding 22. FIG. 1B shows another assembly of luminaries 2 and electrical conductor 3 in a single loop light string 11, in which the luminaries 2 via extendable conducting wire 21 are welded with the electrical conductor 3 at welding locations 23. FIGS. 1C-1D show further assemblies of luminaries 2 and electrical conductor 3 as the same as in FIG. 1B, but at pressure press 24 and at twisted winding and re-welding 25 respectively.

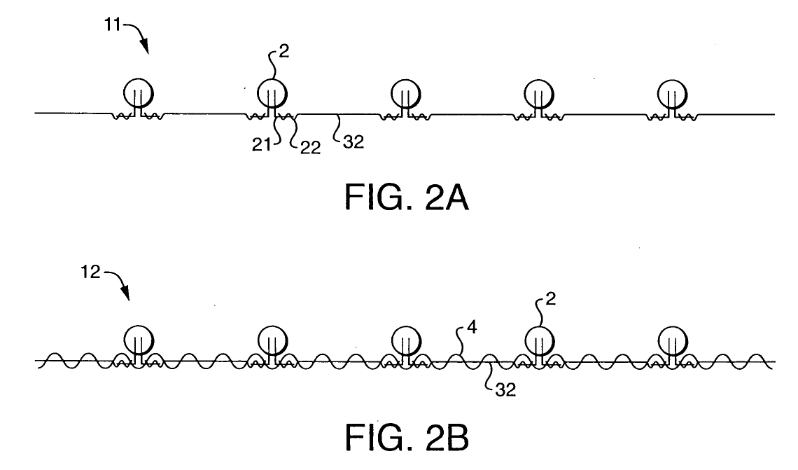

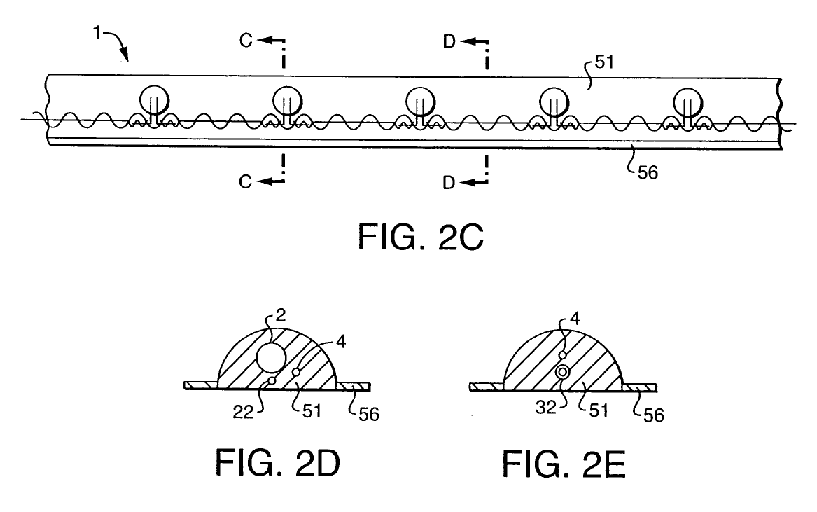

FIGS. 2A-2D show a flexible light string with single loop light string 11 or multi-loops light string 12 within an insulator 5. FIG. 2A shows an assembly of luminaries 2 and open copper lead wire 32 in a single loop 11 of light string 1, in which the luminaries 2 via extendable conducting wire 21 are twisted and wound with open copper lead wire 32 at twisted winding 22. FIG. 2B shows the same as in FIG. 2A, but the open copper lead wire 32 is twisted and wound with a non-electrical connector 4. FIG. 2C shows a flexible decorative light string 1 to be sealed in an insulator 5, in which the insulator 5 is a solid part 51 and has a fringe 56. FIG. 2D shows a cross-section of FIG. 2C through line C-C. The insulator 5 is a semi-circular part 55 with solid portion 51 and having fringe 56 on both sides. The luminary 2 is placed at the center and the twisted winding 22 below it and a non-electrical connector 4 is provided near the twisted winding 22. FIG. 2E shows a cross-section view of FIG. 2C through line D-D, in which the insulator 5 is a solid part 51 and the fringe part 56 on both sides of the insulator. Further, the open copper lead wire 32 and non-electrical connector 4 are at the center of the insulator.

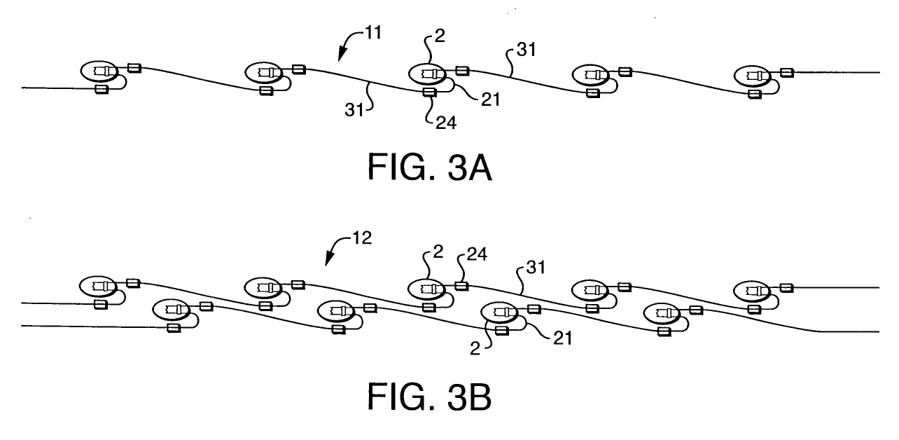

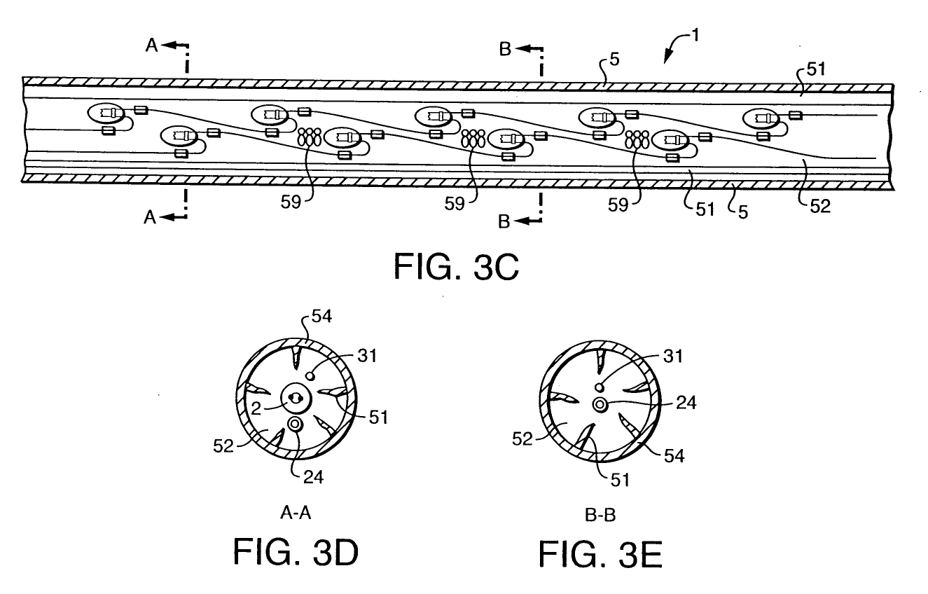

FIGS. 3A-3E show another type of flexible decorative light string 1 with single loop light string 11 or multi-loops light string 12 within an insulator 5. FIG. 3A is an assembly of luminaries 2 and insulating conducting wire 31 in a single loop 11 of light string 1, in which the luminaries 2 via extendable conduction wire 21 are welded with insulating conducting wire 31 at pressure press 24. FIG. 3B shows assemblies of luminaries 2 and insulating conducting wire 31 in multi-loops of light string 1. The structure shown in FIG. 3B is the same as in FIG. 3A. FIG. 3C shows a flexible decorative light string 1 to be sealed in an insulator 5, in which the insulator 5 is a solid part 51 and has reflectors 59. FIG. 3D shows a cross-section of FIG. 3C, through A-A, in which the insulator 5 is a circular part 54 with a solid part 51 and having a hollow region 52 inside the circular part 54 of the insulating body 5. The luminary 2 is placed at the center with the pressure press 24 below it and the insulating conducting wire 31 being above the luminaries 2. FIG. 3E shows a cross-section of FIG. 3C, through line B-B, in which the insulator has a solid part 51 and a hollow region 52 inside the insulator. Further, the insulating conducting wire 31 and the welding 24 are at the center of the insulator 5.

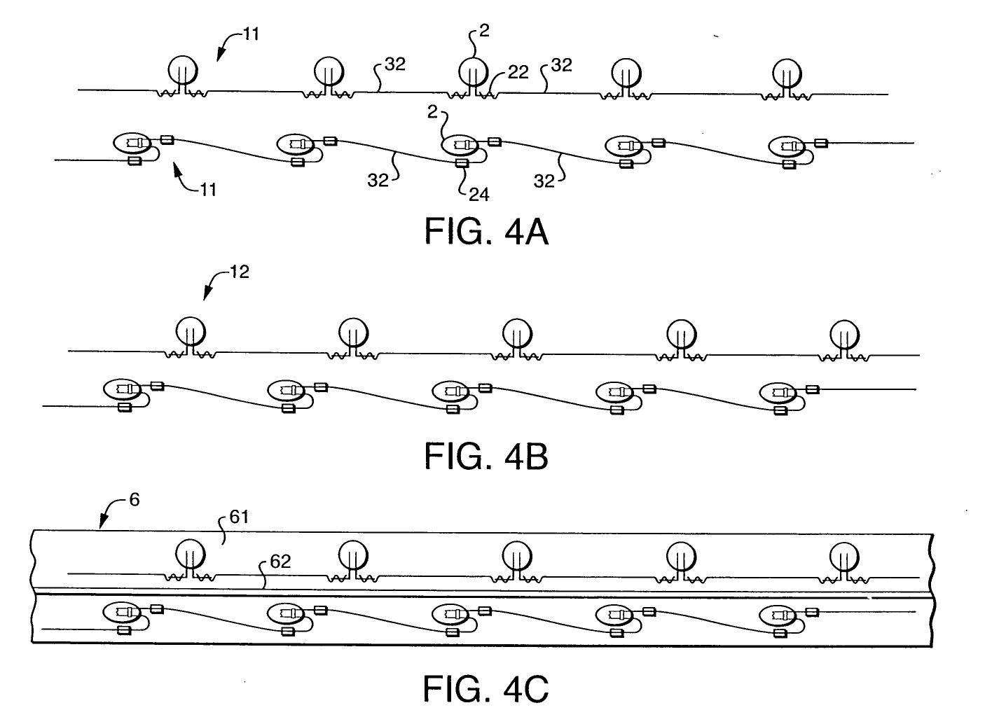

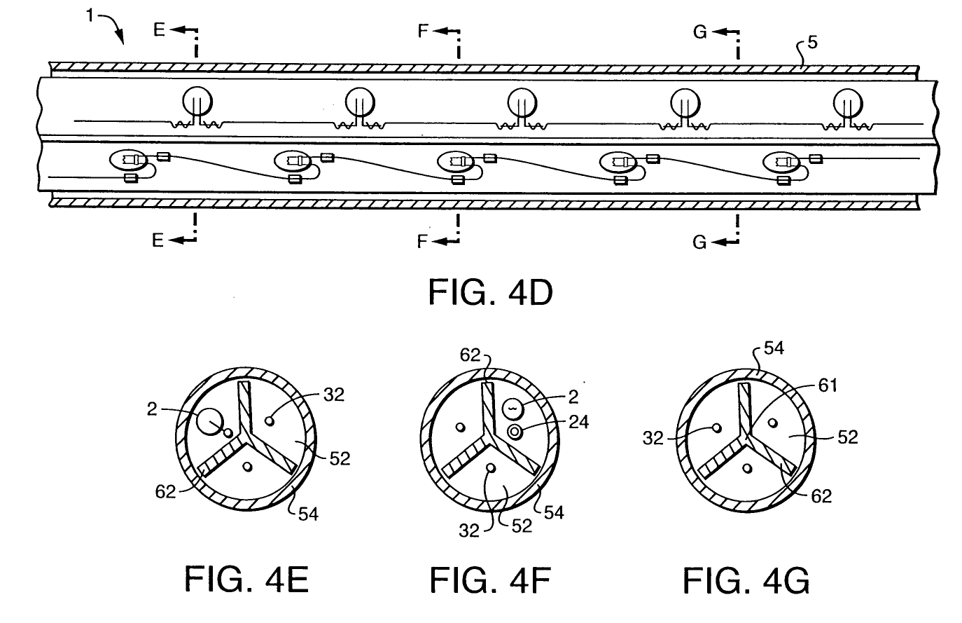

FIGS. 4A-4G show a further type of flexible decorative light string 1 in single loop light string 11 or multi-loops light string 12 within an insulator 5. FIG. 4A shows assemblies of two different kinds of light strings, in which the luminaries 2 via extendable conducting wire 21 are connected to open copper lead wire 32 at twisted winding 22 and pressure press 24 receptively. FIG. 4B is the same as in FIG. 4A, but the light string are multi-loop light strings 12. FIG. 4C shows the flexible decorative light strings fixed by using a positioning device 6, in which the positioning device 6 has a spacer 62 and spaced bars 61. The spacer 62 and spaced bars 61 are used to separate the flexible decorative light strings 1 in order to prevent light strings from short circuiting. FIG. 4D shows the flexible decorative light strings 1 to be sealed in an insulator 5. FIG. 4E is a cross-section view of FIG. 4D in E-E line, in which the insulator 5 is a circular part 54 with a hollow region 52 and having a Y form spacer 62 to separate flexible decorative light strings 1. The luminary 2 in a light string is placed at one side of the Y form spacer 62 and the open copper lead wire 32 and another light string is placed at another side of the spacer 62. FIG. 4F shows a cross-section of FIG. 4D through line F-F, in which the insulator 5 is a circular part 54 with a hollow region 52 and having a Y form spacer 62 to separate flexible decorative light strings 1. The luminary 2 with pressure press 24 in a light string is place at one side of the Y form spacer 62 and the open copper lead wire 32 in another light string in placed at another side of the spacer 62. FIG. 4 G shows a cross-section of FIG. 4D through line G-G. The structure is the same as FIG. 4F, in which the open copper lead wires 32 are separated by the spacer 62.

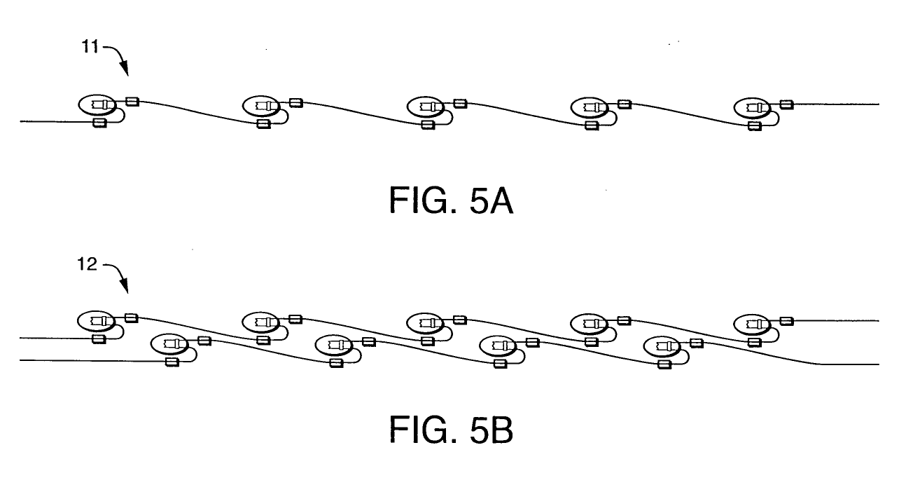

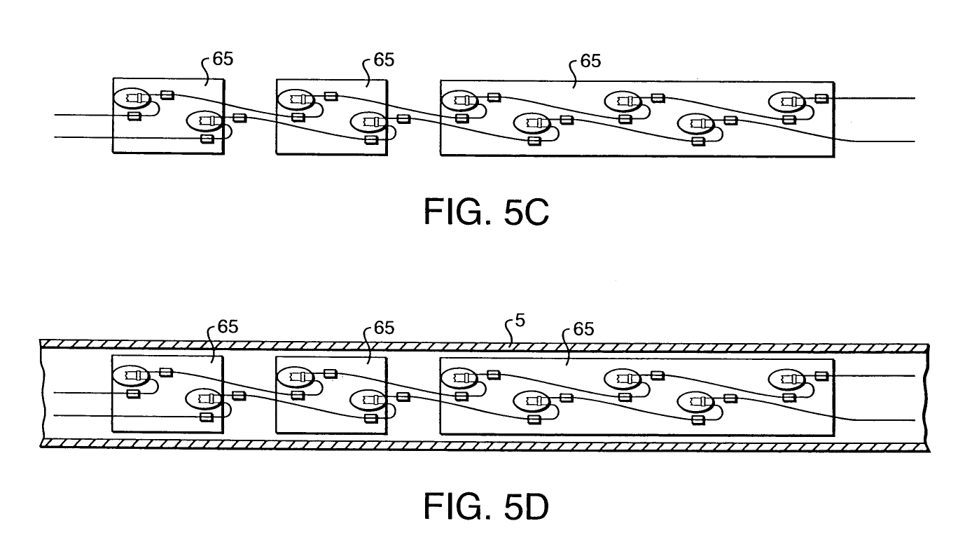

FIGS. 5, 5A-5E show a further type of flexible decorative light string 1 in single loop light string 11 or multi-loops light string 12 within thermosetting tube (sleeve) 65 in an insulator 5. FIG. 5A shows an assembly of a flexible decorative light string 1 with a single loop light string 11. FIG. 5B shows assemblies of flexible decorative light strings 1 with multi-loops light string 12. FIG. 5C shows flexible decorative light strings 1 within thermosetting tube 65, in which the thermosetting tubes 65 are able to adjust their length freely. FIG. 5D shows the structure of flexible decorative light strings 1 in FIG. 5C to be sealed in an insulator 5, in which the thermosetting tube 65 are the relative places within the insulator 5.

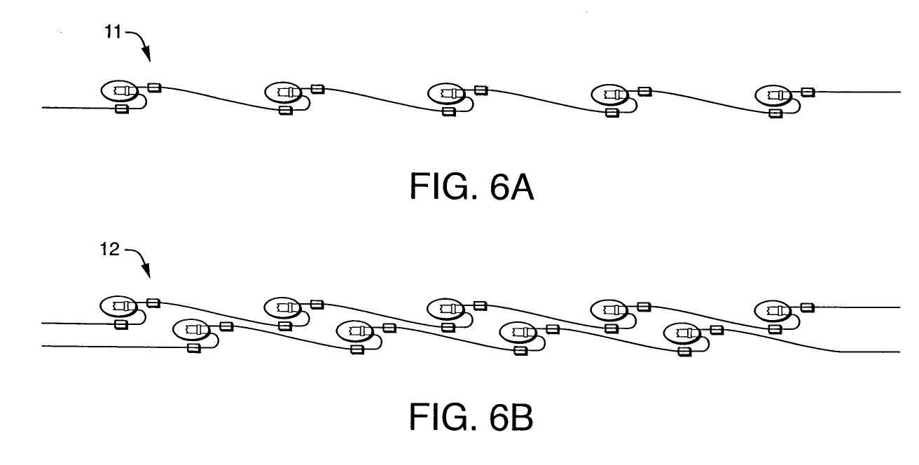

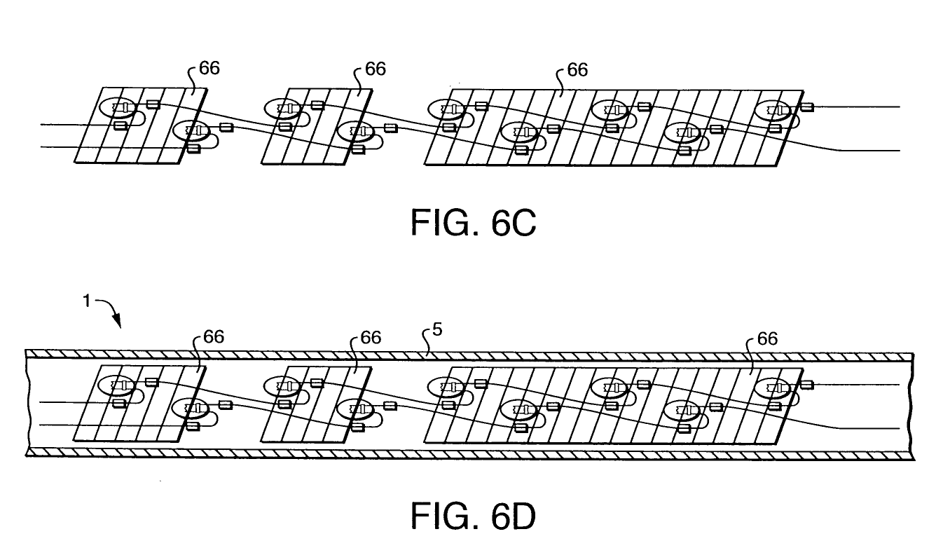

FIGS. 6A-6D show a further type of flexible decorative light string 1 in single loop light string 11 or multi-loops light strings 12 sealed by adhesive tape 66 in an insulator 5. The structures of FIGS. 6, 6A-6D are same as those of in FIGS. 5, 5A-5D, but the adhesive tape 66 is used instead of the thermosetting tube 65.

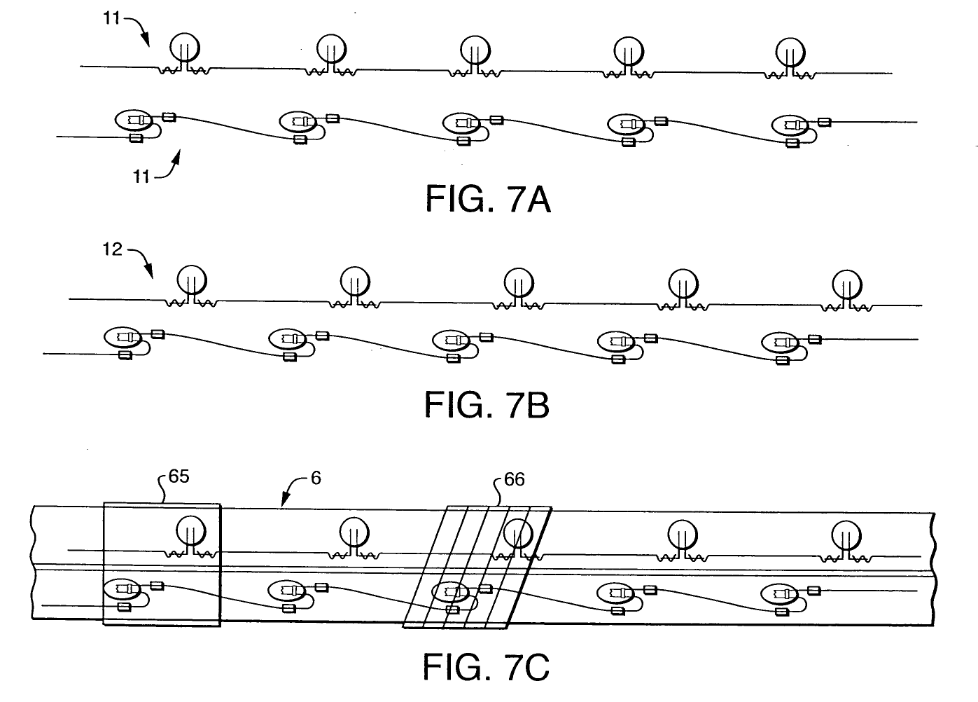

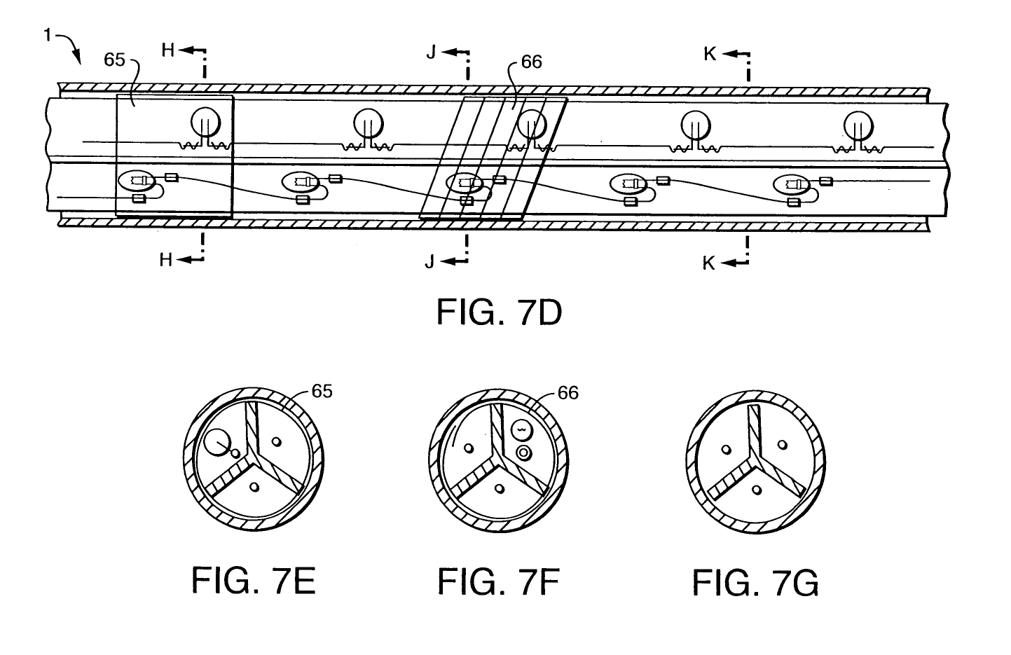

FIGS. 7A-7G show a further type of flexible decorative light strings 1 in single loop light string 11 or multi-loop light string 12 with thermosetting tube 65 and adhesive tape 66 in the insulator 5. The structures in FIGS. 7A and 7B are the same as those of in FIGS. 4A and 4B. The structures in FIGS. 7C and 7D are the same as those of in FIGS. 4C and 4D, in which the difference being that thermosetting tube 65 and adhesive tape 66 are used in the embodiments of FIGS. 7C and 7D. The structure of FIG. 7E is identical with that of in FIG. 4E, in which there is a thermosetting tube 65 to seal the light strings 1. FIG. 7F shows a cross-section of FIG. 7D through line J-J. The structure of FIG. 7F is identical with that of in FIG. 4F, in which there is an adhesive tape 66 to seal the light strings 1. FIG. 7G shows a cross-section of FIG. 7D through line K-K. The structure shown in FIG. 7G is identical with that of in FIG. 4G.

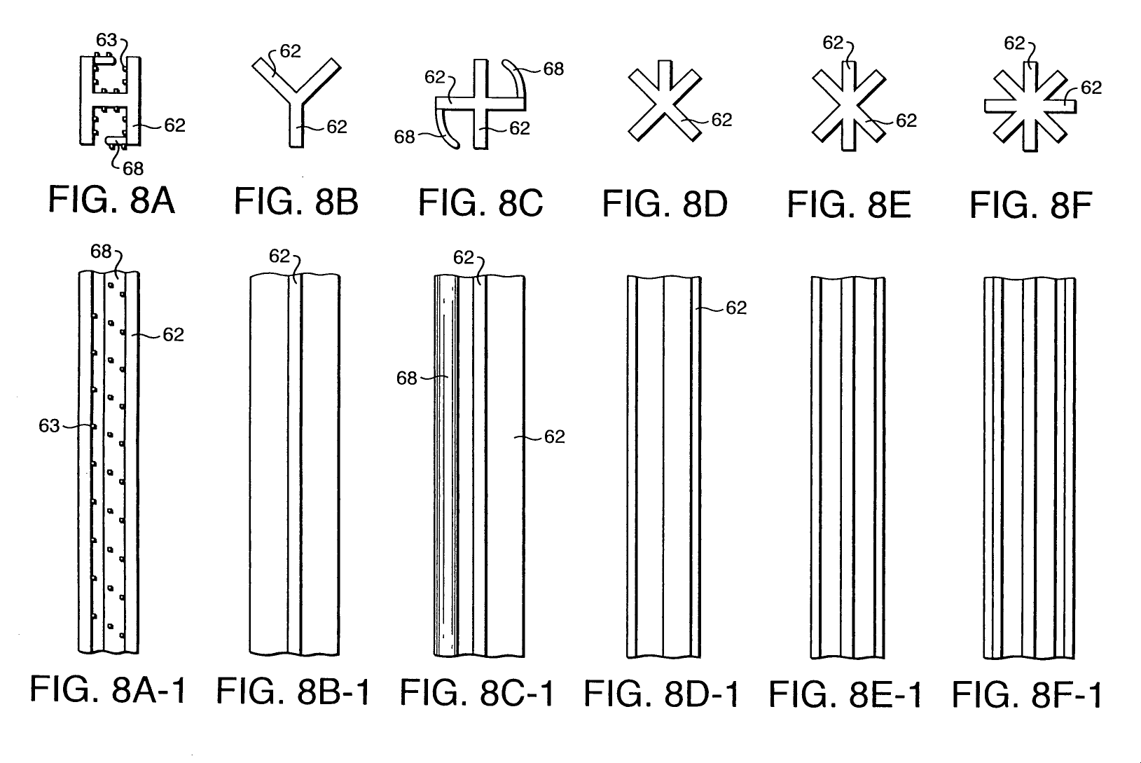

FIGS. 8A-8F, 8A-1 to 8F-1 show positioning devices 6 to be used to separate the light strings 1. FIG. 8A shows a cross-section of an H shape of spaced bar 61, in which spacer 62 is used to separate the light strings 1 and inner wall of the spacer 62 is to form convex and concave spacer 63. One end of spacer 62 in the upper part has a spacer fringe 68 to be used as fixed article. FIG. 8A-1 shows the spaced bar 61 of FIG. 8A in a longitudinal direction. FIG. 8B shows a cross-section of Y form of spaced bar 61. FIG. 8B-1 shows a spaced bar 61 of FIG. 8B in a longitudinal direction. FIG. 8C shows a cross-section view of + form of spaced bar 61. Both ends of the spacers 62 in the horizontal direction have spaced fringe 68 to be used as a fixed article. FIG. 8C-1 shows the spaced bar 61 of FIG. 8C in a longitudinal direction. FIG. 8D shows a cross-section view of a ★ form of spaced bar 61. FIG. 8D-1 shows the spaced bar 61 of FIG. 8D in a longitudinal direction. FIG. 8F shows a cross-section view of * form of spaced bar 61. FIG. 8F-1 shows the spaced bar 61 of FIG. 8F in a longitudinal direction.

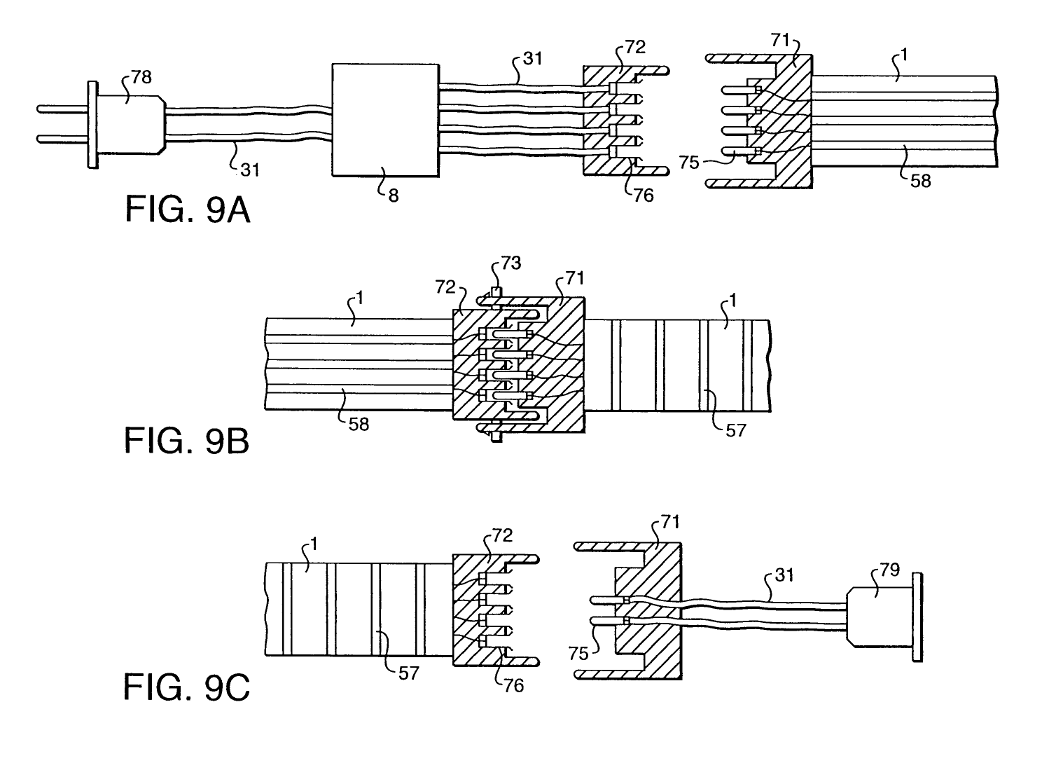

FIGS. 9A -9C show a connector 7 in the flexible decorative light string 1 of the present invention. FIG. 9A shows an exploded view of a connector 7 in a light string 1, in which an electrical plug 78 via insulating conducting wire 31 is connected to a function controller 8 and the function controller 8 via insulating conducting wire 31 connect to a connector 7. The connector 7 has two parts of male part 71 and female part 72, in which there are male connecting terminal 75 and female connecting terminal 76 respectively. FIG. 9B shows a fastening status of the connector 7 of two light strings, in which a female part 72 connector is connected by outward longitudinal convex and concave 58 in a light string 1, and a male part 71 connector is connected by outward horizontal convex and concave 57 in a light string 1. FIG. 9C shows an exploded view of another type of connector of a light string 1, in which a female connector part 72 is connected by outward horizontal convex and concave 57 in a light string 1, and a male connector part 71 is connected by insulating conducting wire 31 to an end connector 78. A female connecting terminal 76 and a male connecting terminal 75 are provided in the male part 71 and female part 72 connectors respectively.

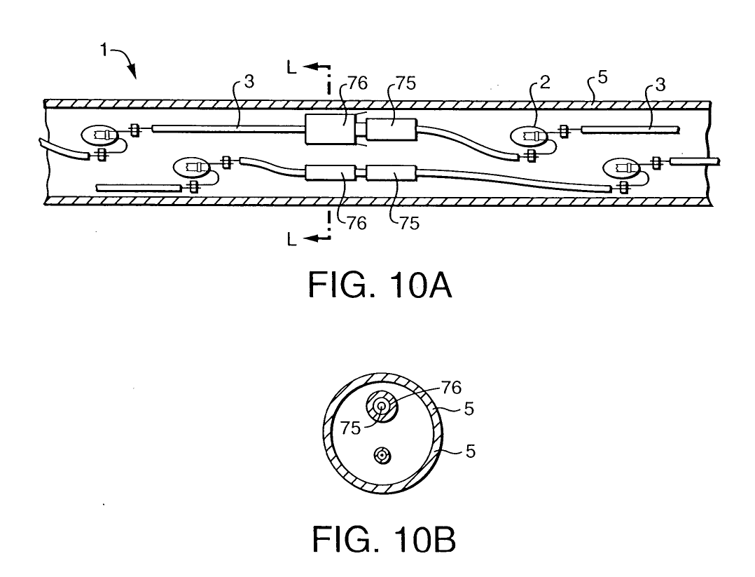

FIGS. 10A-10B show a further type of the connectors 7 in the light strings 1 within an insulator 5. FIG. 10A shows the connectors 7 is a light string within an insulator 5, in which electrical conductors 3 are respectively connected to female connecting terminal 76 and male connecting terminal 75 of the connector. FIG. 10B is a cross-section of FIG. 10A through line L-L, in which, the male connecting terminal 76 is in a light string 1 within an insulator 5.

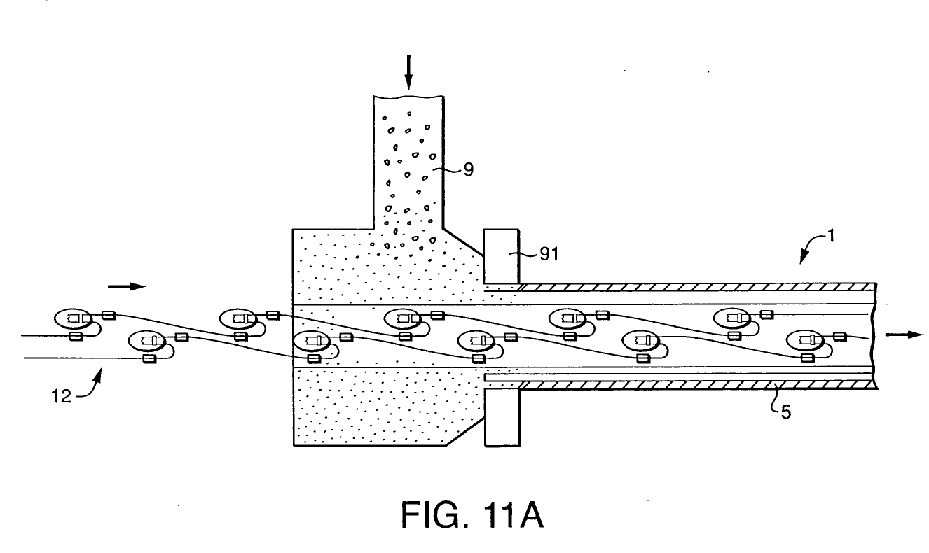

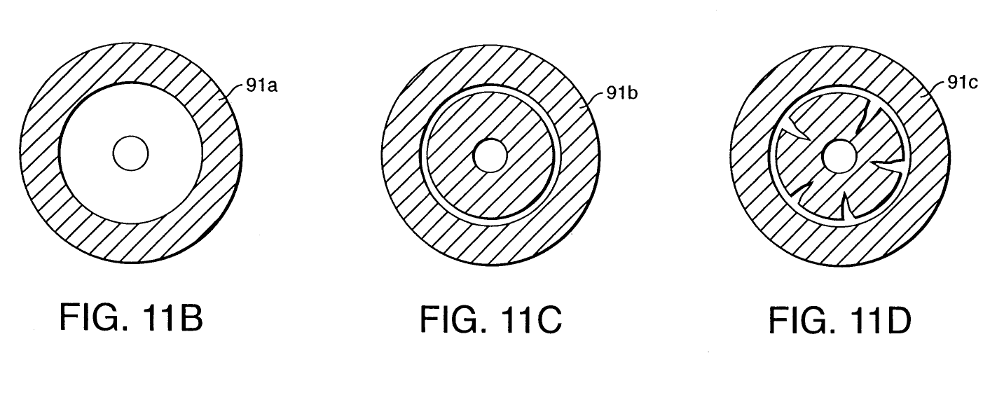

FIGS. 11A-11D show a cross-section of a light string 1 with insulator. FIG. 11A shows a sectional view of light strings 1 with multi-loops light string 12. The light strings 1 enter an extruder 9 and via die 91 to extrude out of the extruder 9 to form a flexible direction light string 1 with insulator 5. FIG. 11B shows a cross-section with solid insulating body 91a of light string 1 in FIG. 11A. FIG. 11C shows a cross-section with a hollow region insulating body 91b of light string 1 in FIG. 11A. FIG. 11D shows a cross-section with a hollow region insulating body with an extension strip 91C of light string 1 in FIG. 11A.

The positioning device can be formed of, or include, a material to store energy received as light from the luminaries and the environment, and to continue to emit light after the luminaries cease to emit light

The feature and preferred embodiments of the prevention invention have been described in foregoing specification. The invention intended to be protected herein is not to be constructed as limited to the particular form disclosed. Variations and changes may be made by those skilled in the art are without departing from the scope of the present invention.

What is claimed is:

1. A flexible decorative light string comprising:
multiple luminaries connected with multiple electrical conductors in one of a series arrangement, a parallel arrangement and a series and parallel arrangement to form grouped light strings;
an insulator along with said grouped light strings extending in a longitudinal direction of said light strings to contain and seal the luminaries and the electrical conductors within said insulator, whereby the luminaries and the electrical conductors are isolated from an outside environment and along with said insulator form a flexible decorative light string;
wherein one or both ends of said string are connected to electrical connectors to form a circuit loop;
wherein the flexible decorative light string can be flexed to fit in to a transportation and storage volume which is smaller than an in-use volume; and
wherein when one end of the light string is fixed the other end of the light string sags, and when the light string is supported at two points the light string between the two points drapes.

2. A flexible decorative light string as claimed in claim 1:
wherein the luminaries have multiple conducting wires extending to the outside of said luminaries, able to connect to electrical conductors, the luminaries being connected to the electrical conductors, said luminaries and said electrical conductors being parallel to a longitudinal direction of said light string.

3. A flexible decorative light string as claimed in claim 1, wherein the luminaries are one of vacuum bulbs, bulbs filled with gas and LEDs.

4. A flexible decorative light string as claimed in claim 1:
wherein conducting wires of the luminaries are strung together with the electrical conductors, wherein said conducting wires and said electrical conductors are twisted and wound about each other and one of welded, pressure pressed, and twisted and wound about each other and re-welded to form a connection.

5. A flexible decorative light string as claimed in claim 1: wherein the electrical conductors have insulators.

6. A flexible decorative light string as claimed in claim 1:
wherein the luminaries are connected to the electrical conductors to form a single loop light string having two ends, both ends of said string being connected to the positive pole and negative pole of an electrical source.

7. A flexible decorative light string as claimed in claim 6:
wherein the single loop light string is twist wound with the electrical conductors to increase the connection strength.

8. A flexible decorative light string as claimed in claim 1:
wherein the light strings can be connected into multi-loop light strings in series, said multi-loop light strings being able to be twisted into a bundle.

9. A flexible decorative light string as claimed in claim 8:
wherein the multi-loop light strings and connectors are connected to a functional controller to make individual light strings perform various functions which are pre-determined in said controllers.

10. A flexible decorative light string as claimed in claim 1:
wherein on the electrical conductors, I/O terminals are attached and sealed in an insulating body in order to connect or to separate the light strings.

11. A flexible decorative light string as claimed in claim 10:
wherein said I/O terminals are one of different colors and different shapes used to recognize a positive pole and a negative pole.

12. A flexible decorative light string as claimed in claim 10:
wherein the terminals are indexed to connect only in a certain orientation to assure a certain connection polarity.

13. A flexible decorative light string as claimed in claim 1:
wherein the connectors of the circuit loops are used to connect said circuit loops to each other, wherein said connectors are separable and connectable to respectively shorten the length of the light string and to increase the length of the light string.

14. A flexible decorative light string as claimed in claim 13:
wherein the connectors are connected to both ends of the light string, in which one connector is male and the other connector is female and equipped with a fastening device, the male connector and the female connector being connected and fastened, said connectors being resistant to disassembly.

15. A flexible decorative light string as claimed in claim 14:
wherein the male connector connects to the female connecting terminal of an electrical outlet to supply power to the light string.

16. A flexible decorative light string as claimed in claim 13:
wherein the connectors are indexed to connect only in a certain orientation to assure a certain connection polarity.

17. A flexible decorative light string as claimed in claim 1:
wherein the insulator is formed from soft plastic which is extruded, wherein said insulator is one of transparent, translucent and a various color.

18. A flexible decorative light string as claimed in claim 17:
wherein the soft plastic is PVC or a PVC mixture.

19. A flexible decorative light string as claimed in claim 17:
wherein the insulator is solid or hollow.

20. A flexible decorative light string as claimed in claim 19:
wherein the hollow insulator has several longitudinal extension strips, and one end of said strips is connected to said insulator to one of reflect and refract, and to fix the light strings.

21. A flexible decorative light string as claimed in claim 1:
wherein the insulator has one of a circular, a half-circular and an arbitrarily shaped cross-section.

22. A flexible decorative light string as claimed in claim 21:
wherein a lateral side of the insulator has a fringe, which is able to be fixed to another body.

23. A flexible decorative light string as claimed in claim 21:
wherein a surface of the insulating body has a convex and concave shape.

24. A flexible decorative light string as claimed in claim 21: wherein the surface of the insulator has one of a lateral convex and concave shape, and a longitudinal convex and concave shape.

25. A flexible decorative light string comprising:
multiple luminaries connected with multiple electrical conductors in one of a series arrangement, a parallel arrangement, and a series and parallel arrangement to form grouped light strings, by means of a positioning device extending along a predetermined length for multiple luminaries to separate or to fix the light strings in a certain position;
an insulator along with said grouped light strings extending in a longitudinal direction of said light strings to contain and seal the luminaries and the electrical conductors within said insulator, the luminaries and the electrical conductors being isolated from an outside environment and along with said insulator forming a flexible decorative light string with one or both ends of said string connected to connectors to form a circuit loop.

26. A flexible decorative light string as claimed in claim 25:
wherein the electrical conductors are open copper lead wires and are connected to conducting wires of said luminaries to form said decorative light strings.

27. A flexible decorative light string as claimed in claim 25:
wherein the positioning device has a spacing profile with transparent soft plastic insulating material separating said electrical conductors so as to separate the circuit loops to prevent them from forming a short circuit.

28. A flexible decorative light string as claimed in claim 25:
wherein the spacing profile is based on the quantities of circuit loops having spacers with a cross-sectional shape of two to eight channels to separate the electrical conductors within the spacers.

29. A flexible decorative light string as claimed in claim 25:
wherein the spacers on the spacing profile have a fringed or convex and concave shape so as to increase fixed function, reflective and refraction effect.

30. A flexible decorative light string as claimed in claim 25:
wherein a positioning device having a fixing article to fix the electrical conductors and luminaries in a certain position is used to prevent the electrical conductors and luminaries from being bent causing a short circuit.

31. A flexible decorative light string as claimed in claim 30:
wherein the fixing article is formed of soft thermosetting tube, said thermosetting tube fixing the electrical conductors and said thermosetting tube fixing the luminaries being individually or jointly by being heated and contracted to tightly fix in position said electrical conductors and said luminaries.

32. A flexible decorative light string as claimed in claim 30:
wherein the fixing article is soft adhesive tape, and the electrical conductors and the luminaries are twisted and wound individually or jointly by said tape and fixed in position by said tape.

33. A flexible decorative light string as claimed in claim 30:
wherein the fixing article has spaces to fix the decorative light strings in a certain position.

34. A flexible decorative light string as claimed in claim 25:
wherein the positioning device has a spacing profile and fixed articles.

35. A method for the preparation of a flexible decorative light string, comprising:
forming a string of multiple luminaries connected to multiple electrical conductors to form a circuit loop of a single loop light string;
combining together single loop light strings in one of series and parallel to form one of single and multiple circuit loops of grouped light strings; and
extrusion molding plastic with an extruder to make a grouped light string sealed within insulting plastic via a predetermined die of said extruder forming a flexible decorative light string with an outward insulating body.

36. A method for the preparation of a flexible decorative light string as claimed in claim 35:
further comprising twisting and winding conducting wires of the luminaries with the electrical conductors and one of welding, pressure pressing, and twisting and winding to each other and re-welding or pressure pressing.

37. A method for the preparation of a flexible decorative light string as claimed in claim 35:
further comprising twist winding the single loop light string with non-electrical lines to increase the string strength.

38. A method for the preparation of a flexible decorative light string as claimed in claim 35:
further comprising forming a multi-loop circuit of grouped light strings in parallel from several single loop light strings.

39. A method for the preparation of a flexible decorative light string as claimed in claim 35:
further comprising passing the light string through a die of an extruder, applying an outward insulating body sealing the light string within, wherein the extruder is being used to heat plastic and melt said plastic for extrusion about the light string in a cross sectional shape of the flexible decorative light string.

40. A method for the preparation of a flexible decorative light string as claimed in claim 39:
further comprising using dies with different shapes to extrude a hollow or solid insulating body.

41. A method for the preparation of a flexible decorative light string as claimed in claim 35:
further comprising using dies with different shapes to form the insulating body having a cross-sectional shape of one of a circle, simi-circle and other arbitrary shape.

42. A method for the preparation of a flexible decorative light string as claimed in claim 35:
further comprising using dies with different shapes to form the surface of the insulating body with one of lateral convex and concave shapes and longitudinal convex and horizontal concave shapes.

43. A method for the preparation of a flexible decorative light string, comprising:
connecting multiple luminaries to multiple electrical conductors to form a circuit loop of a single loop light string;
combining together single loop light strings in one of series and parallel to form one of single and multiple circuit loops of grouped light strings;
fixing a position of the light strings with a spacing profile or fixing article to fix the decorative light strings in a certain position; and
extrusion molding plastic with an extruder to make a grouped light string sealed within insulating plastic via a predetermined die of said extruder, forming a flexible decorative light string with an outward insulating body

44. A method for the preparation of a flexible decorative light string as claimed in claim 43:
further comprising using a spacing profile based on the quantities of circuit loops having spacers with a cross-sectional shape of two to eight channels to separate the electrical conductors within the spacers to prevent a short circuit.

45. A method for the preparation of a flexible decorative light string as claimed in claim 43:
further comprising heating and contracting tightly thermosetting tube individually or jointly about the electrical conductors and luminaries for fixation in certain positions.

46. A method for the preparation of a flexible decorative light string as claimed in claim 43:
further comprising twisting and winding individually or jointly the electrical conductors and luminaries with adhesive tape for fixation in certain positions.

47. A method for the preparation of a flexible decorative light string as claimed in claim 43:
further comprising fixing the electrical conductors and luminaries in a certain position by way of dividers.

48. A method for the preparation of a flexible decorative light string as claimed in claim 43:
further comprising simultaneously fixing the electrical conductors and luminaries in certain positions with spacing profiles or fixed articles.

49. A method for the preparation of a flexible decorative light string, comprising:
connecting multiple luminaries to multiple electrical conductors to form a circuit loop of a single loop light string;
combining together single loop light strings in one of series and parallel to form one of single and multiple circuit loops of grouped light strings;
fixing a position of the decorative light strings using a spacing profile or fixed article;
extrusion molding plastic with an extruder to make a grouped light string sealed within insulating plastic via a predetermined die of said extruder, forming a flexible decorative light string with an outward insulating body; and
arranging electrical connectors or functional controllers to shorten or increase the length of said decorative light strings, or to increase various pre-determined functions in said controllers of the flexible decorative light strings.

50. A method for the preparation of a flexible decorative light string as claimed in claim 49:
further comprising connecting to the electrical connectors multiple terminals, in which one is male and the other is female.

51. A method for the preparation of a flexible decorative light string as claimed in claim 49:
further comprising connecting connectors connected to both ends of the light strings, in which one is male and the other is female, the male and female connectors being connected to each other to form chains of light strings.

52. A method for the preparation of a flexible decorative light string as claimed in claim 49:
further comprising forming integral, or arranging fastening devices on each male or female connector wherein after the male and female connectors are connected and fastened, said fastening devices are resistant to disassembly.

53. A method for the preparation of a flexible decorative light string as claimed in claim 49:
further comprising forming the connectors with multiple sets of male and female I/O terminals for the connection of multiple circuit loops.

54. A method for the preparation of a flexible decorative light string as claimed in claim 49:
further comprising forming connectors arranged on both ends of said decorative light strings by one of molding in place and mechanically attaching.

55. A method for the preparation of a flexible decorative light string as claimed in claim 50:
further comprising connecting the male connecting terminal of the decorative light strings to the female connecting terminals of an electrical outlet with insulating electrical conductors whereby to be connected to and to draw power from.

56. A method for the preparation of a flexible decorative light string as claimed in claim 49:
further comprising equipping the light string with an end connector connected to a male connecting terminal with insulating electrical conductors to be connected by a female connecting terminal of the decorative light strings and to supply power.

57. A method for the preparation of a flexible decorative light string as claimed in claim 55:
further comprising arranging multiple functional controllers based on quantities of circuit loops in the electrical connectors and the decorative light strings.

58. A method for the preparation of a flexible decoration light string, comprising:
(1) to string connection: multiple luminaries connected multiple electrical conductors to form a circuit loop of a light string;
(2) to combine together: single loop light string being connected in series or parallel to form a single or multiple circuit loops of rectangular light strings;
(3) to fix position: to use spaced bar or fixed article to fix the decoration light strings in a certain position;
(4) to extrude mould: to use plastic extruder to make the rectangular light string in the longitudinal direction to be sealed within the insulting plastic via predetermined die of said extruder to form flexible decoration light string with outward insulating body.
(5) to arrange electrical connectors or functional controllers whereby to shorten or increase the length of said decoration light strings, or to increase the pre-determined various functions in said controllers of the flexible decoration light strings.

59. A method for the preparation of a flexible decoration light string as claimed in claim 58, wherein the connectors having multiple terminals, in which one being male and the other being female connected to the electrical connectors.

60. A method for the preparation of a flexible decoration light string as claimed in claim 58, wherein the connectors being connected to both ends of light strings, in which one being male and the other being female, the male and female being connected each other to form the light strings much length.

61. A method for the preparation of a flexible decoration light string as claimed in claim 58, wherein the connectors being integral or arranged fastening device on each male or female connectors, after the male and female being connected and fastened, said connectors being not easy to loose.

62. A method for the preparation of a flexible decoration light string as claimed in claim 58, wherein the connectors based on the quantities of circuit loop to make several sets of male and female I/O terminals in each connectors for the connection of circuit loops.

63. A method for the preparation of a flexible decoration light string as claimed in claim 58, wherein the connectors being extrusion moulding or mechanically arranged on the both ends of said decoration light strings.

64. A method for the preparation of a flexible decoration light string as claimed in claim 58, wherein the electrical appliances, connectors, or electrical plugs being connected to female connecting terminal with insulating electrical conductors whereby to be connected by the male connecting terminal of decoration light strings and to supply the power.

65. A method for the preparation of a flexible decoration light string as claimed in claim 58, wherein the connectors equipped with end connector being connected to male connecting terminal with insulating electrical conductors whereby to be connected by the female connecting terminal of decoration light strings and to supply the power.

66. A method for the preparation of a flexible decoration light string as claimed in claim 64, wherein the multiple functional controllers being arranged based on the quantities of circuit loops in the electrical plugs and the decoration light strings.
